(19) United States
(12) Patent Application Publication
(10) Pub. No.: US 2024/0033834 A1
(43) Pub. Date: Feb. 1, 2024

(54) DEVICE WITH A ROTATIONALLY DRIVABLE MILLING BODY

(71) Applicant: Schweerbau International GmbH & Co. KG, Stadthagen (DE)

(72) Inventor: Frank Mevert, Lauenhagen (DE)

(21) Appl. No.: 18/258,361

(22) PCT Filed: Dec. 10, 2021
(86) PCT No.: PCT/EP2021/085214

§ 371 Date: Jun. 20, 2023

(30) Foreign Application Priority Data
Dec. 22, 2020 (DE) 10 2020 134 660.3

(51) Int. Cl. B23C 3/00; E01B 31/13

(52) U.S. Cl. CPC B23C 3/005; E01B 31/13; B23C 2260/12

(57) ABSTRACT

An apparatus includes a milling member capable of being driven in a rotational manner, and a plurality of blade carriers attached to the milling member. Each blade carrier has a blade for chip-removing processing of a profile. A first group of blade carriers is capable of being moved relative to the milling member. Each movable blade carrier is arranged so as to be able to be radially deflected on the milling member by an actuation member during a rotating movement of the milling member. The actuation member cyclically comes into contact with a formation of the blade carrier. In a first functional position, exclusively the blades of the first group of movable blade carriers of a track path move into engagement with the profile. In a second functional position, exclusively blades of a second group of blade carriers of the same track path move into engagement with the profile.

### CROSS REFERENCE TO RELATED APPLICATIONS

This application is a U.S. National Phase application under 35 U.S.C. § 371 of International Application No. PCT/EP2021/085214, filed on Dec. 10, 2021, and claims benefit to German Patent Application No. DE 10 2020 134 660.3, filed on Dec. 22, 2020. The International Application was published in German on Jun. 30, 2022 as WO 2022/135975 A1 under PCT Article 21(2).

### FIELD

Embodiments of the present invention relate to a mobile apparatus for chip-removing processing of a profile, such as a rail of a track member.

### BACKGROUND

As a result of comparatively high axial loads and high travel speeds, rails are often loaded up to the yielding point of the rail material and are therefore subjected to wear which has an unfavorable effect on the transverse profile, particularly in the region of the running face of the rail head.

In order to overcome the ripples and waves which are produced on the running face of track rails during travel operation and which excite the wheel sets of the vehicles to vibrations which disrupt the smoothness of the vehicles, bring about excess wear of the track superstructure and the vehicles and allow vehicle noise to be produced, a wear-dependent reprocessing is required.

To this end, for example, a method for processing rail tracks is known, in which there are used a large number of rotating grinding plates which are arranged beside each other and one behind the other, wherein a portion of the grinding plates is inclined in accordance with the original profile of the rail heads. With such a grinding method, a better approximation to the original profile of the rail heads can be achieved.

So-called cup grinders which are moved at the end face into engagement with the rail surface and which are preferably positioned with a tilting angle with respect to the rail surface to be ground are also known.

In order to grind the heads of rail tracks, so-called rubbing blocks are also used. In this instance, grinding trains are used at the lower side of which grinding stones which are guided under pressure over the rail surfaces are arranged. The rubbing block grinding is based on an oscillating translational movement of the grinding member along the rail during the movement of the vehicle. As a result of the contouring of the grinding members which during use adapt their shaping with continuing wear, in principle a good surface quality and dimensional accuracy are achieved.

EP 2 525 933 B1 relates to an apparatus for the chip-removing reprocessing of the running face of a rail head with a frame which is guided along the rail head. The processing tools are in the form of face milling cutters which can be rotatably driven in opposing directions and the rotation axes of which extend in a common plane and the cutting regions of which overlap each other transversely relative to the longitudinal direction of the rail head.

In order to increase the processing speed, it is known, for example, from DE 32 22 208 A1 to use milling tools, of which the blades which are distributed in several axial groups over the circumference of the cutter head reproduce the rail head profile.

However, the curved cutting path, which is determined by such a circumferential milling, of the individual blades of the milling tool leads to a surface of the rail head which is undulating in the longitudinal rail direction, wherein the surface quality becomes worse with increasing advance speed as a result of the increasing spacing of the chip removal operations of successive blades.

WO 02/06587 A1 also describes a method for reprofiling at least the convex portion of the rail head cross sectional profile of a rail by means of circumferential milling with more than five milling paths which are located beside each other in the longitudinal direction of the rail.

Additional apparatuses for chip-removing reprocessing, particularly for milling rail heads which are laid in the track, are described in the documents EP 0 952 255 B1, U.S. Pat. No. 5,549,505 A, EP 0 668 398 B1, EP 0 668 397 B1, U.S. Pat. No. 4,275,499 A; EP 0 148 089 A2 and DE 32 22 208 C2.

Furthermore, for example, DE 28 41 506 C2 discloses apparatuses in which the rail heads are processed with a so-called track plane. The disadvantage with planes, particularly with respect to the milling methods, are a higher force requirement in the advance direction, a long chip and/or the often relatively long idle times.

AT 400 863 B describes an apparatus for the chip-removing reprocessing of a rail head using a revolving tool which is guided along the processing strip and in which the blades are held in carriers and form the links of a link chain which is continuously guided around redirecting wheels.

In order to obtain a planar surface, the generic EP 2 177 664 A1 proposes moving the blade during the chip-removing processing of the workpiece along a linear path so that a reprocessing, for example, a grinding, can be dispensed with. From EP 2 177 664 A1 it is further also known to activate the blades of individual track paths of the transverse profile separately, for example, also in an outer track path which is associated with the lateral side of the rail, by different track paths being associated with independent actuation members.

It is thereby possible, for example, in the example of track processing in the region of the core piece, the wing rails and the tongues of a set of points, for one or more track paths to be deactivated so that in the portion of the transverse profile corresponding to this track path no processing and consequently no material removal is carried out. Such a removal which is in principle undesirable otherwise leads to unsuitable transverse profile geometries of the set of points. For example, in the region of the core piece two tracks converge so that a distinction of the lateral portion and the central portion of the transverse profile is not carried out in this region.

In practice, it is conventional not to provide for the surface of the transverse profile in the central region of the running face any inclination or concave geometry with respect to the edge region.

It has been found to be disadvantageous in practice that in the edge region of the transverse profile of a set of points by deactivating the corresponding track path in accordance with the principle of the technical teaching disclosed in EP 2 177 664 A1, the processing can be temporarily interrupted. However, as a result of simple deactivation of the corresponding blades in practice during the milling processing operation, no continuous path of the transverse profile is produced. Instead, deviating transverse profile portions with, for example, undesirable irregularities may occur. In addition, the profile remains unprocessed in this transverse profile portion so that in particular defect locations which are close to the surface, such as, for example, cracks, cannot be removed.

### SUMMARY

An apparatus includes a milling member capable of being driven in a rotational manner, and a plurality of blade carriers attached to the milling member. Each blade carrier has a geometrically determined blade for chip-removing processing of a profile of a rail of a track member. The profile has a transverse profile. A first group of the plurality of blade carriers is capable of being moved relative to the milling member. In order to adjust different working positions during engagement of the blade of the respective movable blade carrier in the profile, each movable blade carrier is arranged so as to be able to be radially deflected on the milling member by an actuation member during a rotating movement of the milling member. The actuation member cyclically comes into contact with a formation of the blade carrier. The formation has an inclination. In a first functional position, exclusively the blades of the first group of movable blade carriers of one or more track paths move into engagement with the profile. In a second functional position, exclusively blades of a second group of the plurality of blade carriers of a same track path of the one or more track paths move into engagement with the profile.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a side view of an apparatus according to an embodiment of the invention having a milling member as a carrier of a plurality of blade carriers during the milling processing operation of a profile;

FIG. 2 shows an enlarged, cut-out illustration of a movable and a non-movable blade carrier of different groups of the apparatus according to an embodiment;

FIG. 3 shows a side view of the apparatus with a plurality of blade carriers which are arranged beside each other in parallel tracks according to an embodiment;

FIG. 4 shows an enlarged illustration of a first functional position for deflecting all the movable blade carriers and a second functional position for deflecting individual track paths of associated movable blade carriers according to an embodiment;

FIG. 5 shows an enlarged illustration of two possible transverse profiles according to the different functional positions shown in FIG. 4, according to an embodiment;

FIG. 6 shows an enlarged illustration of two blade carriers, which can be moved independently of each other, of different groups in the same track path, according to an embodiment; and

FIG. 7 shows a plan view of the plurality of blade carriers which are arranged in six parallel tracks, according to an embodiment

### DETAILED DESCRIPTION

Embodiments of the present invention provide a mobile apparatus having a milling member which can be driven in a rotationally movable manner and which has a plurality of blade carriers which are arranged on the circumference and which each have a geometrically determined blade for the chip-removing processing of a profile, in particular a rail of a track member, wherein the profile has a transverse profile having a central region which forms a running face and having at least one convex edge region, wherein the apparatus has blade carriers which can be moved relative to the milling member and, by means of at least one adjustable actuation member on the milling member, which are arranged so as to be able to be radially deflected in order to adjust different working positions during the engagement of the blade of the respective movable blade carrier in the profile in such a manner with respect to a rotation axis of the milling member that a cutting depth of the blade can be changed by means of the adjustable actuation member during the processing of the workpiece by the actuation member during the rotating revolving movement of the milling member cyclically coming into contact with a cam-like formation, which has an inclination, of the blade carrier and thereby in addition to the rotational movement a constant radial deflection of the blade is carried out in a cyclical manner so that the cutting depth can be adjusted by means of the actuation member.

Embodiments of the present invention enable a processing of different profiles using the apparatus. Furthermore, different transverse profile geometries are intended to be able to be produced during the processing of the profile. Furthermore, a method for processing by means of which during the processing of the profile different transverse profile geometries can be produced is intended to be provided.

According to some embodiments, there is provided an apparatus in which there can be adjusted, as a result of at least one actuation member, a first functional position of the movable blade carrier in which exclusively the blades of a first group of movable blade carriers of a track path or a plurality of track paths move into engagement with the profile, and alternatively a second functional position or other functional positions, in which exclusively the blades of a second group or another group of a plurality of blade carriers, which are arranged on the milling member, of the same track path or the same track paths move into engagement with the profile, wherein the blade carriers of the first and second group are not identical. It is recognized that with respect to each individual one of a possible plurality of track paths for processing different transverse profile portions in each case different forms and geometries can be produced by the at least one actuation member as a result of different functional positions. To this end, within a specific track path, as a result of the actuation member, different groups of blade carriers are activated or deactivated in order thus to produce transverse profile geometries which are different but which are consistent over the entire cross section profile and which can in particular be adapted to the specific requirements placed on a different transverse profile in the region of a set of points with respect to other track portions of the profile.

In some embodiments, the radial deflection is not limited to an enlargement of the spacing from the rotation axis of the milling member. Instead, the desired temporary planar movement path of the blade can be achieved by superimposing the rotating movement and a radial movement which is directed inward or outward with respect to the rotation axis.

To this end, according to an embodiment of the apparatus, at least individual blade carriers of the blade carriers of the second group are arranged in a non-movable manner on the milling member by at least individual blade carriers being arranged during the processing in a state distributed over the circumference on the milling member in at least one track path of the milling member in a non-movable manner with respect to or relative to the milling member, the blades of these blade carriers only move into engagement when the blades of the movable blade carrier are not deflected radially outward, in particular are thus completely deactivated. To this end, for example, at least in one track path on the circumference of the milling member, movable and fixed blade carriers are arranged alternately and form the different groups, wherein the movable blade carriers protrude in the radially outwardly displaced position thereof radially with respect to the fixed blade carriers. In a set of points, the movable blade carriers of this track path, for example, the lateral track path, are deactivated so that only a reduced cutting depth and consequently the reduced removal of the fixed blades is carried out. The transverse profile is consequently raised with respect to an alternative processing by the blades of the movable blade carriers as a result. In the other functional position, the removal is limited as a result of the larger radial extent to the movable blade carriers. Consequently, different profiles can be initially produced where necessary in the same track path and in each case produce a homogeneously and consistently extending transverse profile geometry.

In this instance, for instance, embodiments of the invention are not limited to the combination of movable and non-movable blade carriers. Instead, all the blade carriers of the various groups can be configured to be movable and may alternatively be able to be deflected by means of separate actuation members so that during the milling processing operation different profiles are produced and in this instance the advantages of the so-called rotary plane, that is to say, the milling processing operation with a partially planar movement path which is parallel with the longitudinal extent of the profile and the associated improved processing quality for the different groups of the blade carriers and accordingly for different transverse profile geometries are achieved.

The movable blade carriers of various groups have to this end, for example, convex formations as a contact face for the respective actuation member which are arranged in different cross section planes with respect to the rotation axis of the milling member so that a plurality of adjacent actuation members which are associated with the same track path can be achieved. Preferably, in the direction parallel with the rotation axis of the milling member, a plurality of adjacent actuation members are also together not wider than the transverse profile portion which is intended to be processed with the associated blade carriers of this track path.

The apparatus is also not limited to two groups of blade carriers in a respective track path. Instead, in principle, three or more groups can also be produced, wherein a mechanical deflection by means of a contacting actuation member as a result of the spatial relationships present is linked with additional structural complexity. In the cases of three and more groups, the movable blade carriers can preferably be radially deflected by means of suitable actuation members which are arranged on the milling member and which are consequently in the form of actuators which rotate together with the milling member, wherein a control unit is used in particular also for wireless transmission of control instructions for the actuation members or the actuators. The control instructions can also be produced taking into account track information, in particular, that is to say, the position and relevant parameters of sets of points, so that an automatic processing can be carried out.

In practice, it has already been found to be advantageous in tests for the apparatus to have a plurality of blade carriers which are arranged beside each other in different cross section planes of the milling member which are parallel in the direction of the rotation axis in adjacent track paths, wherein movable blade carriers are arranged in at least one track path which is associated with a running face of the transverse profile and different groups of blade carriers with movable and non-movable blade carriers are arranged in at least one track path which is associated with a lateral and/or a medial edge region of the transverse profile. The alternative milling processing operation for producing different geometries of a specific transverse profile portion is therefore limited to the transverse profile regions at both sides of the running face so that in the region of the increased quality requirements, as apply to the running face, all the blade carriers are used to produce the same geometry and accordingly in a state distributed over the circumference, a greater number of blade carriers are available for the running face profile, the blade carriers of which engage with a shorter spacing in the profile than the bade carriers of alternately activatable groups.

The milling member preferably has a large number of blade carriers which are arranged with spacing from each other in a circumferential direction. Another embodiment is also achieved by adjacent blade carriers of different track paths being arranged with an offset in a circumferential direction, wherein the offset between the adjacent blade carriers in a state distributed over the circumference and/or between the blade carriers of a plurality of parallel track paths is in each case consistent. Ins some embodiments, the uniform offset of the blade carriers of adjacent track paths is greater than zero. The blade carriers of the same track path and the adjacent track paths during a revolution of the milling member thereby engage one after the other in the profile, whereby the processing quality can be further improved.

Furthermore, an embodiment of the invention is also achieved in that the movable and/or non-movable blade carriers of different groups of the same track path are arranged alternately and/or in a state distributed uniformly on the profile member in a circumferential direction so that a homogeneous material removal is achieved by each of the groups. Preferably, the blade carriers of various groups are arranged in corresponding numbers on the milling member in a state distributed in a uniform manner over the circumference.

The actuation member may act by means of kinematic coupling on the respective movable blade carrier. To this end, the actuation member may be arranged radially internally within the milling member which is to this end in the form of a hollow member or in an annular manner so that the movable blade carriers are radially displaced by means of cyclical contact with the actuation member. In this instance, the actuation member may be in the form of an eccentric member, for example, a cam in order to thus accordingly radially displace the blade carriers. Preferably, the eccentric member is arranged on a camshaft which is driven in a rotationally movable manner with a fixed speed ratio with the milling member, for example, by means of a kinematic coupling.

Furthermore, the deflection of the blade carriers can also be produced by means of a slotted member of the activation member. In a preferred manner, the contact face has an in particular cam-like formation with an inclination, against which the actuation member cyclically abuts in a sliding and/or free-rolling manner during the processing, wherein the formation is geometrically determined and during the milling processing operation is configured in a non-changeable manner but in a replaceable manner, if necessary, and at a side of the blade carrier facing away from the blade is connected thereto, for example, also in an integral manner. The actuation member cyclically strikes the formation during the rotation of the milling member, wherein means known per se may be provided in order to reduce the friction, for example, sliding or rolling contact faces.

In this instance, a multi-axle, relative displacement of the actuation member parallel with the cross section plane of the milling member enables an optimum adjustment possibility during the production of the desired superimposed movement path of the respective blade. Furthermore, actuators, for example, piezo actuators, can also advantageously be used as actuation members.

The cam-like formation can be in the form of a wedge-like or ramp-like contact face, by means of which the blade carrier is radially displaced. In this instance, for the radial deflection with respect to the planar movement path of the blade which is intended to be produced, a non-linear connection is produced so that, according to an embodiment, the cam-like formation is formed at least partially in a concave or convex manner or extends in a non-parallel manner with respect to a tangent on the revolving path of the blade in order to ensure a planar movement path of the blade when the rotating movement and the radial deflection are superimposed.

When the movable blade carriers of various track paths or the various groups of blade carriers of the same track path are activated, it has already been found to be advantageous for the apparatus to have a plurality of actuation members which can be adjusted independently of each other and which are configured to be able to be adjusted relative to each other in order to produce different radial extents.

Of course, the blades may have a shape which is adapted to the surface geometry of the profile which is intended to be produced so that according to a preferred variant the blades of at least individual blade carriers have a concave shape.

The radial deflection of the blade carriers is not limited to a translational movement. Instead, for example, the movable blade carriers may to this end also be movably arranged on lever arms, in particular with a pivot axis of the lever arm, parallel with the rotation axis of the milling member.

Embodiments of the present invention also provide a method for operating the apparatus in that by means of the at least one actuation member within the same track path in the first or second functional position the blades of a first group of movable blade carriers or the blades of a second group of blade carriers arranged on the milling member are selectively brought into engagement with the profile by being radially displaced relative to each other and/or relative to the milling body. In particular, during the processing of the profile and in order to produce different transverse profile geometries of the same profile, at least one actuation member is activated and thereby alternately a first functional position of the movable blade carriers, in which exclusively the blades of a first group of movable blade carriers of at least one track path moves into engagement with the profile, or a second functional position or other functional positions are adjusted, in which exclusively the blades of another group of a plurality of blade carriers, which are arranged on the milling member, of the same track path or the same track paths move into engagement with the profile. According to some embodiments, a plurality of blade carriers which are distributed over the circumference of the milling member and which may be associated with the same or a plurality of track paths are combined to form groups and are activated alternately or where applicable also in combination with each other so that within the same track path different transverse profile geometries of the profile can be produced.

In principle, the blade carriers of the second group when in use during the processing operation can be arranged on the milling member in a non-movable manner, whilst the blades of the blade carriers at least of the first group during the milling processing operation during the engagement in the profile can be moved and in this instance in addition to the rotational movement can also be displaced or deflected radially inward or outward. In this instance, a further improved processing quality in accordance with the principle of the rotating plane is achieved by both groups having blade carriers which can be deflected by means of different actuation members in each case.

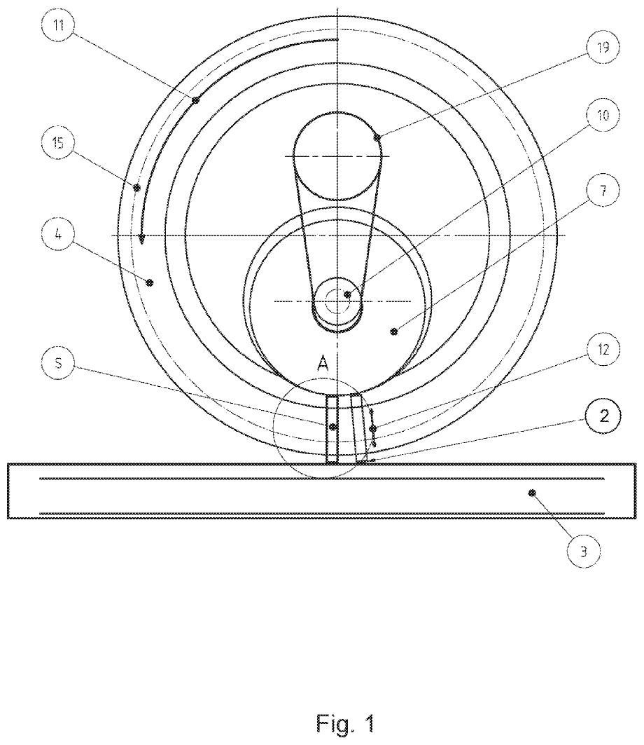

An apparatus 1 according to an embodiment of the invention for milling processing of a profile 3 will be explained in greater detail below with reference to FIGS. 1 to 7. The apparatus 1 has a milling member 4 which can be driven in a rotationally movable manner about the axis 9 during the processing and which acts as a carrier of blade carriers S which are arranged at the circumference and which have a respective blade 2 for the chip-removing processing of the profile 3 which is in the form of a rail of a track member. The objective of the milling processing operation is the smoothing and the reproduction of a desired transverse profile, in particular a running face which is enclosed between the edge regions of the profile 3 for a rail wheel of a rail vehicle which is not shown. In this instance, the specific requirement of the milling processing operation involves preventing to the greatest possible extent surface undulations which in principle in the case of processing with circumferential milling cutters, in particular together with a high advance speed of the mobile apparatus along the profile, cannot be completely prevented.

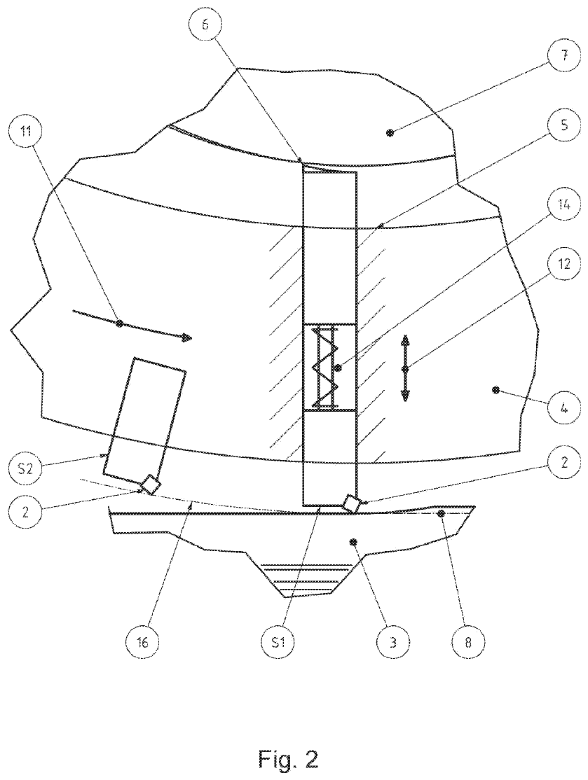

In order to improve the processing quality, in the method which is also described as rotary planing, on the one hand, the blade carrier S is moved together with the milling member 4 on the circular revolving path 15 thereof in the direction of the arrow 11. This movement of the blade 2 corresponds in this instance to the movement of a hobbing cutter. On the other hand, the movable blade carrier S1 is additionally moved with the blade 2 on the milling member 4 in a cyclically radially outward manner. To this end, the blade carrier S1 can be moved in translation in a respective receiving member 5 relative to the milling member 4. As a result of the deflection of the blade carriers S1 in the receiving member 5, the blade 2 is moved over a specific period of time parallel with the surface of the profile 3. A movement of the blade 2 parallel with the surface of the profile 3 corresponds to the movement of a plane known from the prior art. This temporarily parallel movement of the blade 2 is achieved by superimposing the revolving movement on the revolving path 15 and a movement of the blade carrier S1 out of this revolving path 15 in a radial direction in the direction of the arrow 12. The superimposition of the movements indicated with the arrow directions 11 and 12 produces the planar path 8, which is indicated in FIG. 2 with a dashed line, of the working movement 16 of the blade 2.

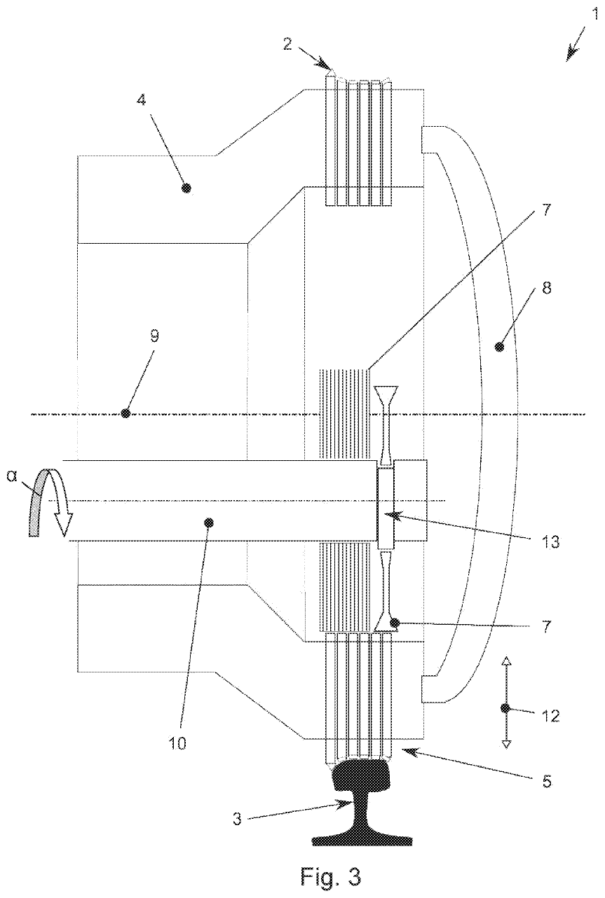

The apparatus 1 has a plurality of blade carriers S1 which can be moved in translation in a receiving member 5 and a plurality of non-movable blade carriers S2. In a state distributed over the circumference of the milling member 4, as illustrated in FIGS. 1 to 3, a large number of blade carriers S1, S2 are arranged one behind the other in the circumferential direction, and, as can be seen in FIGS. 3 to 7, beside each other in a plurality of track paths 18. Each track path 18 serves to process a transverse profile portion of the profile 3.

The movable blade carriers S1 are displaceably arranged in the respective receiving member 5 thereof on the milling member 4 and each have for radial deflection a wedge-like or cam-like formation 6. During the revolving of the milling member 4, the formation 6 of the respective blade carrier S1 is moved along an actuation member 7 which is in the form of a rotational member and which is freely rotatable or is driven in a rotationally movable manner by means of a drive 19. In the event of contact between the actuation member 7 and the formation 6, the blade carrier S1 is deflected in accordance with the wedge-like or ramp-like geometry of the formation 6 by the actuation member 7 in the direction of the arrow 12. The receiving member 5 has a restoring device 14 so that the blade carrier S1 is deflected counter to a restoring force and is moved by the restoring device 14 back into its starting position when the formation 6 no longer touches the actuation member 7.

The milling member 4 which rotates about the axis 9 has in the circumferential direction a plurality of receiving members 5 which are arranged beside each other. In order to process the profile 3, by rolling or sliding the actuation member 7 on the formations 6 at least individual blade carriers S1 which are guided on the receiving members 5 are moved cyclically in the direction of the profile 3, whilst the blade 2 engages in the profile 3.

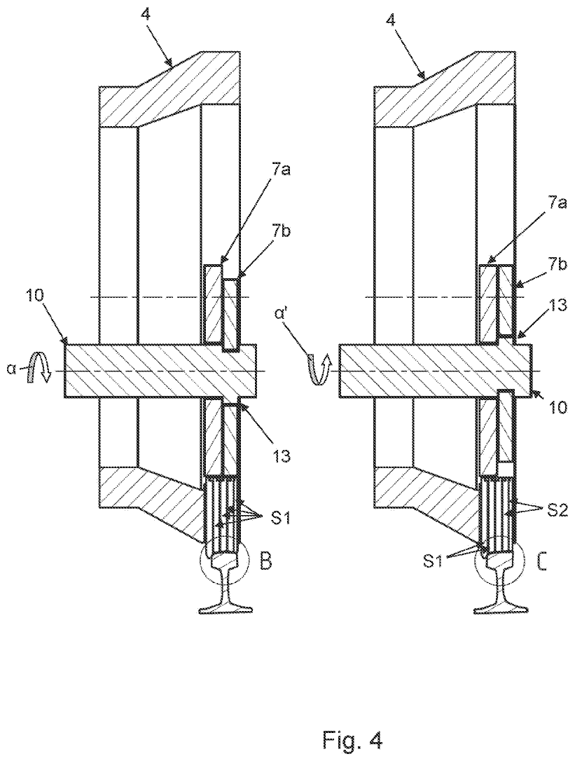

As can be seen in particular in FIGS. 3 and 4, the apparatus 1 according to the embodiment illustrated has two actuation members 7a, 7b which are arranged so as to be able to be freely rotated independently of each other on a shaft 10, wherein naturally according to embodiments of the invention additional actuation members are not excluded. The forces absorbed by the actuation members 7a, 7b in order to deflect the blades 2 are dissipated via the shaft 10.

By changing the angular position α of the shaft 10, the position of an eccentric region 13 of the shaft 10 is changed so that the actuation member 7b which is arranged thereon or supported in the region 13 can no longer act or not with the same amplitude on the associated blade carriers S1 of the associated track path 18. These blade carriers S1 are accordingly no longer deflected or not deflected to such a great extent, whereby the blades 2 of this blade carrier S1 no longer engage in the profile 3 and no or only a significantly limited milling processing operation is carried out.

As illustrated in FIGS. 3 and 4, with a complete revolution of the milling member 4, all the blade carriers S1 with which the actuation member 7a is associated are deflected once, whilst the blade carriers S1 with which the actuation member 7b is associated is deflected only with a corresponding angular position a of the actuation member 7b as illustrated on the left-hand side of the image in FIG. 4.

As illustrated on the right-hand side of FIG. 4, alternatively at least one angular position α′ of the actuation member 7b can be adjusted, wherein the movable blade carriers S1 are not deflected and therefore do not engage in the profile 3. These movable blade carriers S1, which as described can be deflected where necessary or in an adjustable manner, form the first group of movable blade carriers S1.

In addition to the first group of movable blade carriers S1, the milling member 4 further has in the same track path 18 a second group of blade carriers S2 which may be arranged in a circumferential direction, for example, alternately with the blade carriers S1 of the first group. The sum of the movable blade carriers S1 and the non-movable blade carriers S2 of the same track path 18 may correspond or be different and may be adapted to the respective application.

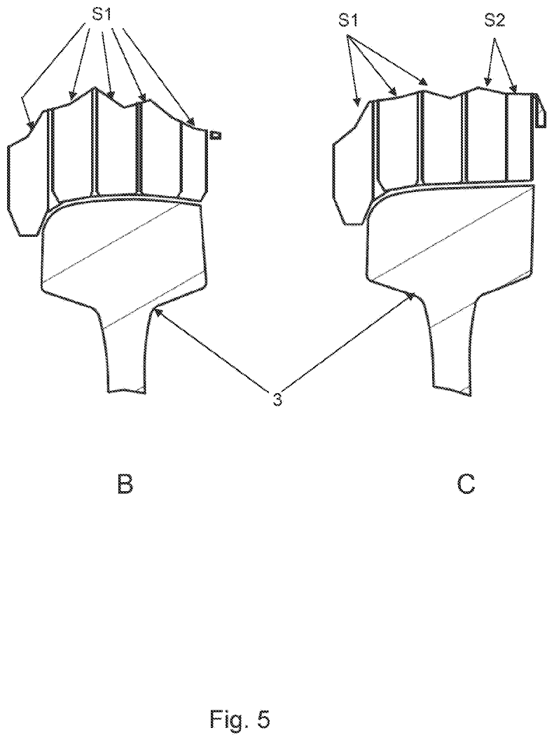

The blade carriers S2 of the second group are non-movable on the milling member 4 during used but preferably fixed so as to be able to be replaced. In the first functional position, the non-movable blade carriers S2 are retracted with respect to the movable blade carriers S1 in such a manner that the blades 2 of the non-movable blade carriers S2 cannot move into engagement with the profile 3. This first functional position and the resulting transverse profile of the blade carriers S1 is illustrated in FIG. 5 at the left-hand side of the image.

In contrast, a second functional position can be adjusted by deactivating the actuation member 7b with the angular position α′ in which exclusively the blades 2 of the non-movable blade carriers S2 which are associated with the second group engage in the profile 3 since the movable blade carriers S1 are retracted with respect to the non-movable blade carriers S2. The second functional position and the resulting transverse profile of the blade carriers S1 and the blade carriers S2 is illustrated in FIG. 5 at the right-hand side of the image. It is thereby also first possible during the uninterrupted milling processing operation, in particular in different path portions of the profile 3, to produce different transverse profile geometries, as required, for example, in the region of sets of points.

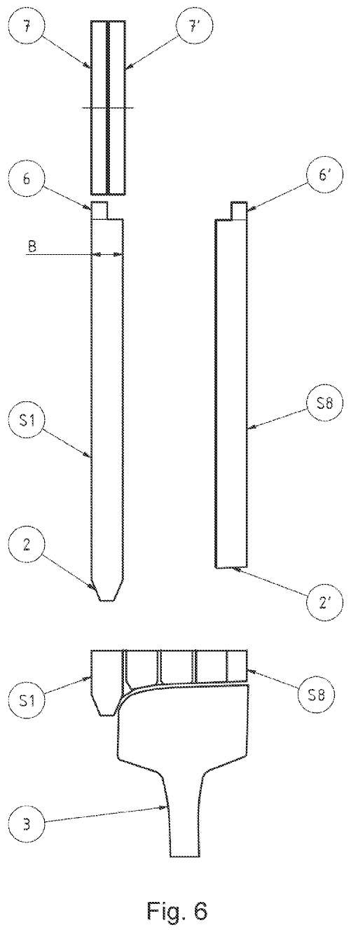

In FIG. 6, a variant of the apparatus 1 is additionally illustrated, wherein there are provided two groups of different blade carriers S1, S8 which, unlike what is shown in FIG. 2, are each in the form of movable blade carriers S1, S8. For better understanding, the different blade carriers S1, S8 are illustrated beside each other in FIG. 6. They are in fact arranged in a circumferential direction one behind the other so that the blades 2 during the milling processing operation alternately move into engagement with the profile 3 in the same track path 18. As can be seen, the formations 6, 6′ of the blade carriers S1, S8 extend from different sides up to approximately half of the width B of the blade carriers S1, S8, wherein the formations 6, 6′ of the blade carriers S1, S8 of the different groups are arranged at different sides. Two actuation members 7, 7′, which can be activated independently in accordance with the principle shown in FIG. 4, thus enable the independent deflection of the blade carriers S1, S8 of different groups during the processing of the same track path 18 along a substantially planar path 8. In other words, both groups of blade carriers S1, S8 comply with the requirements of the rotary plane so that a consistently high processing quality can be achieved and nonetheless, as a result of the use of different blade geometries of the blades 2, 2′ of the blade carriers S1, S8, different transverse profile portions can be produced in the same track path 18.

The actuation members 7, 7′ are to this end arranged in each case eccentrically on the shaft 10 so that a rotational movement of the shaft 10 leads to an alternative deflection of the actuation member 7 or 7′ so that either the blades 2, 2′ of the blade carriers S1 or S8 move into engagement with the profile 3 in the same track path 18. Not illustrated is a possible alternative activation of the blade carriers S1 or S8 by means of a common actuation member which to this end can be moved in an axial direction of the shaft 10 in translation between the illustrated positions of the actuation members 7 and 7′.

The different transverse profile forms which are produced from the alternative activation of the blade carriers S1 or S8 correspond to the transverse profiles shown in FIG. 5, wherein, as a result of the movable blade carriers S1, S8 which are used, the processing quality is accordingly significantly increased.

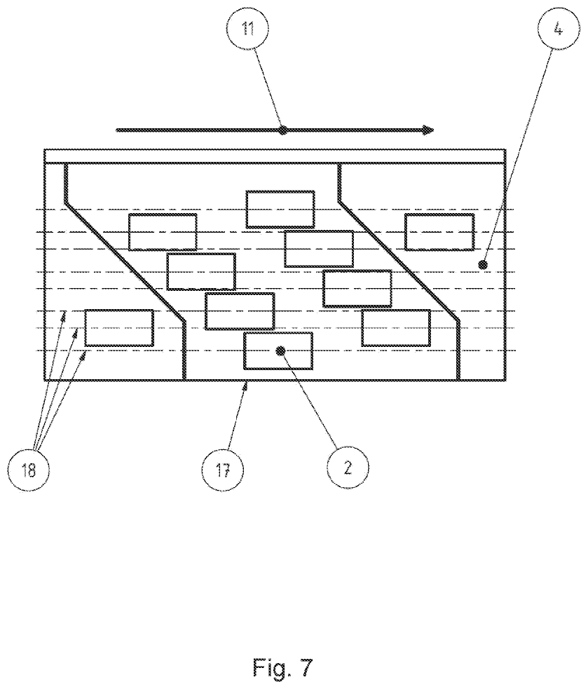

FIG. 7 shows a cut-out of the run-off surface of the milling member 4 with a plurality of blades 2 which are arranged behind and beside each other. The blades 2 are associated with a plurality of parallel track paths 18 in order to prevent track images on the processed surface of the profile 3 illustrated in FIGS. 1 to 3. The milling member 4 which is moved in the direction of the arrow 11 is composed of individual segments 17. The segments 17 can be releasably fixed to the milling member 4.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

LIST OF REFERENCE NUMERALS

| | |
|---|---|
| 1 | Apparatus |
| 2, 2′ | Blade |
| 3 | Profile |
| 4 | Milling member |
| 5 | Receiving member |
| 6, 6′ | Formation |
| 7a, 7b, 7, 7′ | Actuation member |
| 8 | Track |
| 9 | Axle |
| 10 | Shaft |
| 11 | Arrow direction |
| 12 | Arrow direction |
| 13 | Region |
| 14 | Restoring device |
| 15 | Revolving path |
| 16 | Working movement |
| 17 | Segment |
| 18 | Track path |
| 19 | Drive |
| α, α′ | Angular position |
| B | Width |
| S, S1, S2, S8 | Blade carrier |

1. An apparatus comprising:
a milling member capable of being driven in a rotational manner, and
a plurality of blade carriers attached to the milling member, each blade carrier having a geometrically determined blade for chip-removing processing of a profile, the profile having a transverse profile of a rail of a track member, wherein a first group of the plurality of blade carriers is capable of being moved relative to the milling member, and in order to adjust different working positions during engagement of the blade of the respective movable blade carrier in the profile, each movable blade carrier is arranged so as to be able to be radially deflected on the milling member by an actuation member during a rotating movement of the milling member, wherein the actuation member cyclically comes into contact with a formation, which has an inclination, of the blade carrier wherein in a first functional position, exclusively the blades of the first group of movable blade carriers of one or more track paths move into engagement with the profile, and in a second functional position, exclusively blades of a second group of the plurality of blade carriers of a same track path of the one or more track paths move into engagement with the profile.

2. The apparatus as claimed in claim 1, wherein the blade carriers of the second group of the plurality of blade carriers are arranged in a non-movable manner on the milling member.

3. The apparatus as claimed in claim 1, wherein the movable blade carriers of the first group of the plurality of blade carriers and/or movable blade carriers of another group of the plurality of blade carriers are configured to be able to be deflected by a respective actuation member.

4. The apparatus as claimed in claim 2, wherein the plurality of blade carriers are arranged beside each other in a direction of a rotation axis in adjacent track paths, wherein exclusively movable blade carriers are arranged in at least a first track path that is associated with a running face of the transverse profile, and different groups of movable blade carriers and non-movable blade carriers are arranged in at least a second track path that is associated with a lateral and/or a medial edge region of the transverse profile.

5. The apparatus as claimed in claim 4, wherein adjacent blade carriers of different track paths are arranged with an offset in a circumferential direction.

6. The apparatus as claimed in claim 4, wherein the movable blade carriers and/or non-movable blade carriers of different groups of the same track path are arranged in the circumferential direction alternately and/or in a state distributed uniformly on the milling member.

7. The apparatus as claimed in claim 1, wherein the formation is a cam-like formation and has an inclination, against which the actuation member cyclically abuts in a sliding and/or rolling manner during the chip-removing processing processing.

8. The apparatus as claimed in claim 7, wherein the cam-like formation is configured at least partially in a concave and/or convex manner.

9. The apparatus as claimed in claim 1, wherein the apparatus comprises a plurality of actuation members that can be adjusted independently of each other.

10. A method for chip-removing processing of a profile by using an apparatus as claimed in claim 1, the method comprising:
cyclically deflecting a blade during the chip-removing processing of the profile with respect to an axis of the milling member, thereby moving the blade along a planar path, and
during the processing of the profile, in order to produce different transverse profile geometries of the profile, activating at least one actuation member, so that either blades of a first group of movable blade carriers of at least one track path or blades of a second group of blade carriers that are arranged on the milling member of the same track path engage in the profile.
